(19) United States
(12) Patent Application Publication
(10) Pub. No.: US 2006/0088800 A1
(43) Pub. Date: Apr. 27, 2006

(54) Saliva ejector

(76) Inventors: Andreas Neff, Limburgerhof (DE); Marc Gierich, Weinheim (DE)

Correspondence Address: BIRCH STEWART KOLASCH & BIRCH, PO BOX 747, FALLS CHURCH, VA, 22040-0747, US

(21) Appl. No.: 11/254,690

(22) Filed: Oct. 21, 2005

(30) Foreign Application Priority Data
Oct. 23, 2004 (DE) DE 102004051709.6

(51) Int. Cl. A61C 17/06

(52) U.S. Cl. 433/91

(57) ABSTRACT

A device for removing fluids and solid substances by suction from the mouth and oral cavity area during dental-medical treatments is provided. The device includes a first tube segment, a first end of which can be charged with low air pressure, and to the second end of which a sleeve-like ejector tip is attached. By a relative movement of the ejector tip on the tube segment, the ejector tip can be alternated between a first suctioning position and a second suctioning position. In the second suctioning position, only the opening on the upper front side of the second end of the tube segment functions as a suction opening to allow point-focused suctioning with high suction force. In contrast thereto, in the first suctioning position, a plurality of additional suction openings is provided around the circumference to remove fluids from the mouth and oral cavity area by suction. Thus, it is possible to alternate between both suctioning positions without having to disassemble the saliva ejector.

This nonprovisional application claims priority under 35 U.S.C. § 119(a) on German Patent Application No. DE 102004051709, which was filed in Germany on Oct. 23, 2004, and which is herein incorporated by reference.

### BACKGROUND OF THE INVENTION

1. Field of the Invention

The present invention relates to a device for suctioning fluids and solid matter from the mouth and oral cavity of a patient during dental-medical treatments.

2. Description of the Background Art

It is always necessary during dental-medical procedures on patients to remove the saliva that accumulates in the mouth and oral cavity of the patient by suction. For this purpose, saliva ejectors are typically used. Essentially, these consist of a hook-shaped tube segment, the first end of which is charged with reduced air pressure, and the second end of which is hooked into the open mouth of the patient. To prevent the saliva ejector from clinging to the oral mucosa of the patient, which on the one hand is uncomfortable for the patient, and on the other hand diminishes the suctioning function, the second end of the saliva ejector is provided with an ejector tip, which in the area extending beyond the tube end has elongated slits, which are evenly distributed around its perimeter, for suction openings. This assures that aside from some elongated slits covered by the oral mucosa of the patient, there are always other, unencumbered elongated slits at disposal for suctioning.

At the same time, from the dentist's position, it is necessary for certain treatment procedures, for example, for fillings, or the application of an etching gel, to accurately direct high suction forces to the exact spot of treatment. Since the arrangement of lateral elongated slits would be counterproductive to this requirement, it is common practice to remove the tip from the tube and to apply direct suction with the upper front tube opening at the tube end. However, the practical experience has been that this often leads to the loss of the ejector tip, or that it ends up on the floor, so that a new saliva ejector is needed when the treatment is continued.

### SUMMARY OF THE INVENTION

It is therefore an object of the invention to provide a saliva ejector that is equally suitable both for general and point-focused suctioning without having to be disassembled.

A first advantage of the device of the present invention is the option that allows the ejector tip to be moved relative to the tube to alternate between a first suctioning position and a second suctioning position, whereby the ejector tip remains firmly attached to the tube. Possible relative movements can be axial or rotational movements with respect to the longitudinal axis of the tube, and a combination of both. This makes it impossible to lose or drop the ejector tip, and it is assured that only one saliva ejector is needed for each dental-medical treatment.

The device of the present invention is proven to be extremely easy to use and allows the execution of the relative movement with only one hand; in contrast to conventional saliva ejectors, which required both hands to remove the ejector tip. This is very beneficial to a dentist, because a second hand is often not available due to other activities.

Surprisingly, a device of the present invention achieves these benefits without thereby complicating its constructive design. The expanded range of functions as compared to conventional saliva ejectors is achieved in a simple way so that the device of the present invention can be produced without significant price increase over state-of-the-art devices. This allows the manufacturer of devices of the present invention to offer significantly improved saliva ejectors at the same price, which is an indication of the economic advantage of the invention.

A further embodiment of the invention provides for a position stop on the tube section for the ejector tip to prevent an axial or rotational dislodging of the ejector tip, or a combination of the two, beyond the first or second suctioning position. Such a position stop can be performed, for example, with stop surfaces or a ring shoulder on the tube segment. Particularly beneficial is a combination of a restricted guidance and a position stop, as will be described therebelow.

The device of the present invention can also have locking mechanisms, which assure that the ejector tip remains locked in the first or second suctioning position and does not involuntarily get dislodged. In a simple implementation of this idea, the tube is provided with a circumferential thickness at an appropriate point so that by pushing the ejector tip onto the circumferential thickness, a friction fit is created.

In a further embodiment of the invention, a restricted guidance of the ejector tip onto the tube is provided. Thus, the sliding path of the ejector tip along the tube is defined. Preferably, a restricted guidance is formed by a groove and a projection engaging therewith, for example, a peg. Preferably, the groove is thereby arranged on the tube, and the peg is arranged on the ejector tip. In a first alternative form of this embodiment, one or several axially parallel grooves are provided, thus allowing an axial realigning of the ejector tip.

In yet a further embodiment, the groove extends around the tube like a spiral so that, for an axial movement of the ejector tip along the tube, an additional rotation of the ejector tip on the tube is necessary. In a further embodiment, the groove is again arranged in a circle, which defines a rotational movement of the ejector tip around the longitudinal axis of the tube. It is at the discretion of the respective user of the invention, which of the various alternative forms suits him/her better.

The restricted guidance is particularly suitable for simultaneously forming a position stop or a locking mechanism for the ejector tip. The upper front end of the groove thereby already forms a stop surface, where the peg comes to a halt when it reaches one of the two suctioning positions. A locking into place can be achieved when at its end, the restricted guidance defines a change in direction, or even a reverse in direction, for example, a bayonet-type lock.

To make it possible to execute a combined rotational and axial movement of the ejector tip for quickly changing to the other suctioning position without transposition of the fingers, the axial spacing of turns of the spiral-formed groove is high. In this way, a change from one suctioning position to the other one can be achieved with a half or quarter turn, for example.

To allow a secure gripping and moving of the ejector tip, the ejector tip is provided with exterior flutings, either entirely or partially. These can extend annularly, can be longitudinal flutings, or can be a combination of both.

The elongated slits in the second longitudinal segment of the ejector tip can be formed by several longitudinal arms, which project at a lateral mutual distance from the first longitudinal segment. The longitudinal arms can thereby be flexible, and can converge toward their free end. In this way, it is possible to spread the longitudinal arms open with the tube when the ejector tip is attached to the tube so that its upper front opening is available for point-focused suctioning. In order to provide as large a suction surface as possible even in the first suctioning position, it is beneficial for the end of the longitudinal arms to be bent toward the longitudinal axis. In this way, suction slits with parallel longitudinal sides are formed.

According to a further embodiment, the longitudinal arms are conically tapered towards their free end to enlarge the suction surface. The upper front end of the second longitudinal segment can be provided with an opening. This opening can be formed by the freely protruding longitudinal arms alone, or else by connecting the ends of the longitudinal arms peripherally to one another. The forming of such an opening on the upper front side makes it possible to push the tube through so that it can be used for point-focused suctioning. However, it is also possible for the opening of the ejector tip itself to serve as a suction end. The tube is thereby connected to the opening inside the ejector tip.

Furthermore, a two-part construction of the second end of the tube segment can be beneficial. For this purpose, a sleeve-shaped part, particularly an injection-molded part, can be pushed onto the end of the tube segment to be attached to it in this way. In the implementation of the teachings of the present invention, it is essentially solely this part that interacts with the ejector tip. Thus, the manufacture of a device of the present invention is substantially simplified because the tube segment is formed by merely extruding and shortening the length, whereas the more complex part of this embodiment is produced in a separate production step.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a lateral view of a first embodiment of a device of the present invention in a first suctioning position;

FIG. 2 is the device illustrated in FIG. 1 in a second suctioning position;

FIG. 3 is a top view of a free end of the device illustrated in FIG. 2;

FIG. 4 is a diagonal view of a second embodiment of a device of the present invention; and

FIG. 5 is a partial view of an end segment of a further device of the present invention.

### DETAILED DESCRIPTION

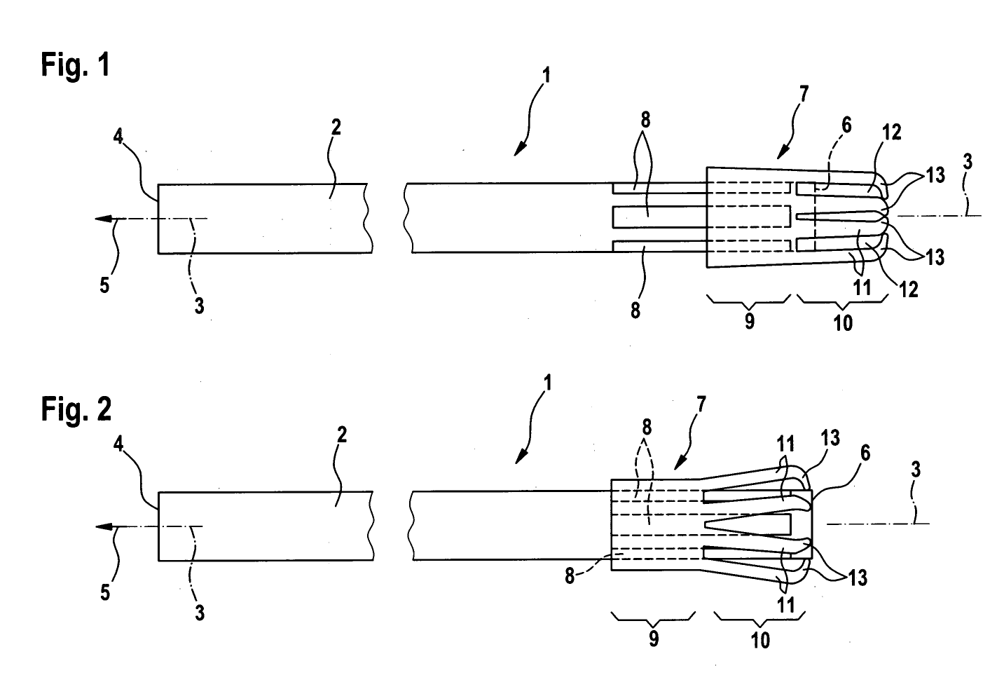

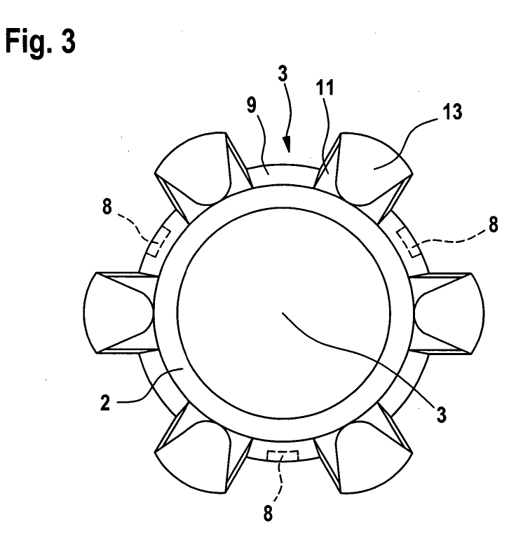

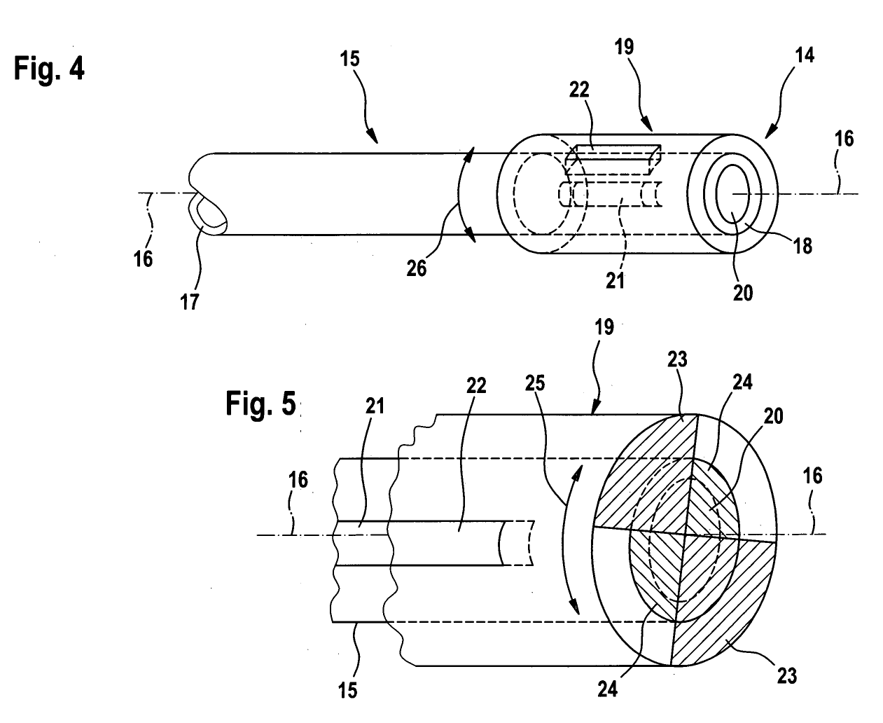

FIGS. 1 and 3 illustrate a first implementation of the invention, as claimed in patent claims 1-14 and 25. FIGS. 4 and 5 illustrate a second implementation of the invention, which is the subject matter of patent claims 15-24 and 25.

FIGS. 1 and 2 are side views of a device 1 of the present invention, whereby FIG. 1 illustrates a first suctioning position of the device 1, whereby general removal of the saliva by suction is performed. FIGS. 2 and 3 are illustrations of the device 1 in a second suctioning position, which is primarily suitable for point-focused suctioning.

The device 1 illustrated in FIGS. 1 to 3 has a tube segment 2 that is arranged along its longitudinal axis 3. The tube segment 2 can be made of a transparent, flexible synthetic material, which may have a steel wire incorporated into its wall for permanent deformation.

The first end 4 of the tube segment 2, which is shown on the left in FIGS. 1 and 2, is connected to a vacuum system (not shown), with which air is continuously suctioned off. The air flow is indicated by arrow 5. The opposite, second end 6 of the tube segment 2 supports an axially adjustable ejector tip 7. In order to allow adjustability on the tube segment 2, the outer circumference of the tube segment 2 is provided with longitudinal grooves 8, which are evenly distributed around its circumference, and which end at a distance before the upper front side of the tube segment 2.

The ejector tip 7 is divided into a first longitudinal segment 9, which encloses the second end 6 of the tube segment 2 in a sleeve-like fashion. On the internal side of the longitudinal segment 9, peg-shaped projections (not shown) are arranged, which extend in a radial direction to the axis 3, and which engage with the longitudinal grooves 8. In this way, the longitudinal grooves 8, together with the pegs, form a restricted guidance for the axial movement of the ejector tip 7 on the tube segment 2. The upper front ends of the longitudinal grooves 8 limit the extend of the movement by forming a position stop for the pegs.

The second longitudinal segment 10 of the ejector tip 7 is formed by six axis-parallel longitudinal arms 11, which are evenly distributed around the circumference while keeping a lateral distance. In this way, six elongated slits 12 are formed, which serve as suction openings of the ejector tip in the first suctioning position. The longitudinal arms 11 have elastic properties so that they spring back into their original position after a deformation. The ends 13 of the longitudinal arms 11 are bent in the direction of the longitudinal axis 3 and can touch one another in the area of the longitudinal axis 3.

To switch to the second suctioning position (FIGS. 2 and 3), the ejector tip 7 is pushed axially in the direction of the first end 4 of the tube segment 2. The ejector tip 7 is thereby guided by the longitudinal grooves 8 and the pegs. The axial movement is stopped by the end of the longitudinal grooves 8, which forms a position stop for each peg.

When pushing the ejector tip 7 onto the tube segment 2, the elongated slits 12 move to the closed area of the tube segment 2, thus losing their suction function. Simultaneously, an expansion of the longitudinal arms 11 by the tube segment 2 takes place, whereby the bent-down and converging ends 13 of the longitudinal arms 11 are supported by the outer side of the tube segment 2. Thus, the entire cross section of the tube segment 2 is cleared so that air is only suctioned in through the upper front, free end of the tube segment 2. The concentration of reduced air pressure on only one opening thus achieved makes a point-focused suctioning with high suction power possible.

FIG. 4 illustrates a further embodiment of a device 14 of the present invention. Shown is a tube segment 15 along an axis 16 with a first end 17, which is designated to be connected to a vacuum system, and a second end 8, which is located opposite the end 17, and which on its upper front side has a suction opening 20 for point-focused suctioning. In the circumferential area close to the end, the tube segment 15 is provided with a plurality of suction openings 21 that are evenly distributed around its circumference, of which only one is representatively illustrated for reasons of layout clarity. The shape of the suction opening 21 can vary (annular, oval, square, rectangular etc.), whereby in the present embodiment, the suction openings 21 are formed by elongated slits.

FIG. 4 also further illustrates a sleeve-shaped ejector tip 19, which are contact-fitted and slidably mounted on the tube segment 15. As can be seen in FIG. 4, the ejector tip 19 can terminate to be flush with the end 18. It is also possible that the upper front end of the ejector tip 19 is arranged with an axial offset to the end 18.

In a simple embodiment, there are no guiding elements provided between the ejector tip 19 and the tube segment 15, which allows the ejector tip 19 to be freely slidable on the tube segment 15. It is also possible to execute axial as well as rotational relative movements, or a combination thereof. A rotational movement of the ejector tip 19 on the tube segment 15 is preferred, as is indicated by arrow 26.

In contrast thereto, it is beneficial to provide guidance, locking, and position stop elements, which define and limit the relative movement between the ejector tip 19 and the tube element 15. These elements are not graphically illustrated in FIGS. 4 and 5 because their constructive design options are already shown in FIGS. 1 to 3 so that reference is made here to the corresponding part of the description.

In its shell, the ejector tip 19 is provided with suction openings 22, which in shape, size, number, and arrangement correspond with the suction openings 21 in tube segment 15. This makes it possible to move the ejector tip 19 from the first suctioning position with non-overlapping suction openings 21 and 22 for point-focused suctioning, as illustrated in FIG. 4, to the second suctioning position with overlapping openings 21 and 22 by relative movement on the tube segment 15, preferably by rotation around the axis 16. In addition to the suction opening 20, transitional openings 21 and 22 for the general removal of the saliva of a patient during treatment are formed.

In the embodiment of the invention illustrated in FIG. 4, the suction opening 20 remains open even in the first suctioning position. Under certain circumstances, this can cause the clinging of the device 14 to the oral mucosa of the patient, which may be uncomfortable. In the further developed embodiment of the invention according to FIG. 5, the upper front end of the ejector tip 19 and the tube segment 15 illustrated in FIG. 4 are modified to form a seal.

To form a seal for the opening 20, the upper front end of the ejector tip 19 is divided into four quadrants, whereby sector-shaped cover disks 23 are arranged in the area, two diametrically opposed quadrants are located, while the respective adjacent quadrants remain free. The upper front end 18 of the tube 15 is likewise provided with sector-shaped cover disks 24.

In a first suctioning position (FIG. 5) with overlapping openings 21 and 22, the cover disks 23 and 24 are arranged to one another such that the opening 20 is completely closed. Suctioning is only done via the suction openings 21 and 22.

To change to the second suctioning position for the purpose of point-focused suctioning, the ejector tip 19 is turned by a quarter turn around the axis 16 in the direction of the arrow 25, which puts the suction openings 21 and 22 into a non-overlapping position. Simultaneously, the cover disks 23 and 24 in respectively the same quadrants are pushed on top of each other so that in the remaining two quadrants the opening 20 is unblocked.

As an alternative, it is also possible to form a seal by axially moving the ejector tip 19 on the tube segment 15. In order to close the opening 20, the ejector tip 19 is axially moved until the cover disks 23 and 24 are positioned in the same plane. To open the opening 20, the ejector tip 19 is axially moved on the tube segment 15 until an axial offset between the cover disks 23 and 24 is attained.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for removing suction fluids and solids by from a mouth and oral cavity area during dental-medical treatments, the device comprising:
a tube segment, a first end of which being charged with a low air pressure, the tube segment further including a second end; and
a sleeve shaped ejector tip having at least one suction opening on a peripheral side thereof, the ejector tip being attached to the second end of the tube segment so that in a first suctioning position, a first longitudinal segment of the ejector tip overlaps with the second end of the tube segment in an axial direction and with a second longitudinal segment extending beyond the second end of the tube segment,
wherein, for changing to a second suctioning position, the ejector tip is axially or spirally slidable on the tube segment, and
wherein, in the second suctioning position, the second longitudinal segment of the ejector tip overlaps with the second end of the tube segment, and only an upper front opening on the second end of the tube segment functions as a suction opening.

2. The device according to claim 1, wherein at its second end, the tube segment is provided with a position stop for the first suctioning position and/or the second suctioning position.

3. The device according to claim 1, wherein, in its first suctioning position and/or its second suctioning position, the ejector tip can be locked into place.

4. The device according to claim 1, wherein, in an axial movement on the tube segment, the ejector tip has a restrictive guide.

5. The device according to claim 4, wherein the restrictive guide includes a groove that engages with a projection.

6. The device according to claim 4, wherein the restrictive guide is arranged axially parallel to a longitudinal axis of the tube segment.

7. The device according to claim 4, wherein the restrictive guide is arranged spirally around the tube segment.

8. The device according to claim 7, wherein at a half turn, a spacing of the spiral turns is equal to a length of the ejector tip.

9. The device according to claim 1, wherein the second longitudinal segment of the ejector tip includes a plurality of longitudinal arms, which are arranged at a mutual lateral distance to form elongated slits for the at least one suction opening.

10. The device according to claim 9, wherein the longitudinal arms are elastic and converge toward their free ends.

11. The device according to claim 10, wherein the free end of the longitudinal arms is bent toward the longitudinal axis of the ejector tip.

12. The device according to claim 9, wherein the longitudinal arms are tapered conically toward their free end.

13. The device according to claim 9, wherein the ejector tip is provided with six longitudinal arms, which are evenly distributed around circumference of the ejector tip.

14. The device according to claim 9, wherein on an upper front end of the second longitudinal segment, the ejector tip has an opening.

15. A device for removing fluids and solids by suction from a mouth and oral cavity area during dental-medical treatments, the device comprising:
a tube segment, a first end of which being charged with low air pressure, the tube segment further including a second end; and
a sleeve shaped ejector tip having at least one suction opening, the second end of the tube segment being provided with, on a circumferential side thereof, at least one suction opening, an end of the ejector tip being open and movable on the second end of the tube segment,
wherein, on the basis of an execution of a relative movement on the tube section, the ejector tip can be changed from a first suctioning position with overlapping suction openings to a second suctioning position with suction openings that do not overlap.

16. The device according to claim 15, wherein the relative movement is an axial and/or rotational movement with respect to the axis.

17. The device according to claim 15, wherein, during the relative movement on the tube segment, the ejector tip includes a restrictive guide.

18. The device according to claim 17, wherein the restrictive guide has a groove that engages with a projection.

19. The device according to claim 17, wherein the restrictive guide is arranged axially parallel, spirally, or annular with respect to a longitudinal axis of the tube segment.

20. The device according to claim 17, wherein the restrictive guide extends annularly or spirally along one-fourth of a circumference of the tube segment.

21. The device according to claim 15, wherein; on the second end, the tube segment is provided with a position stop for the first suctioning position and/or the second suctioning position.

22. The device according to claim 15, wherein, in the first suctioning position and/or the second suctioning position, the ejector tip is locked in place.

23. The device according to claim 15, wherein, on an upper front side of the device, a locking mechanism is arranged.

24. The device according to claim 23, wherein the locking mechanism includes at least two plane-parallel cover disks arranged in a radial plane, the cover disks being changed from an overlapping to a non-overlapping position by rotation.

25. The device according to claim 1, wherein the second end of the tube segment is constructed of two parts, the first part being formed by the tube segment, to which the second part is attached, and wherein only the second part interacts with the ejector tip.

26. The device according to claim 15, wherein the second end of the tube segment is constructed of two parts, the first part being formed by the tube segment, to which the second part is attached, and wherein only the second part interacts with the ejector tip.

27. A saliva ejector comprising:
an ejector tip being movably attached to an end of a tube segment, the ejector tip being moveable between a first suction position and a second suction position, the ejector tip including suction openings formed on a circumferential side of the ejector tip and including at least one direct suction opening formed in a plane that is substantially perpendicular to a longitudinal axis of the tube segment,
wherein, in the first suction position, the suction openings formed on the circumferential side of the ejector tip facilitate suctioning of saliva, and
wherein, in the second suction position, only the direct suction opening facilitates suctioning of saliva.

28. The saliva ejector according to claim 27, wherein the suction openings are longitudinal apertures and/or longitudinal slits.
